(19) United States
(12) Patent Application Publication
(10) Pub. No.: US 2021/0009244 A1
(43) Pub. Date: Jan. 14, 2021

(54) PET FLOTATION AND SAFETY VEST DEVICE

(71) Applicant: Kyle Hansen, Castle Rock, CO (US)

(72) Inventor: Kyle Hansen, Castle Rock, CO (US)

(21) Appl. No.: 16/506,964

(22) Filed: Jul. 9, 2019

(51) Int. Cl. B63C 9/08; A01K 29/00; B63C 9/11

(52) U.S. Cl. CPC B63C 9/08; B63C 2009/084; B63C 9/11; A01K 29/00

(57) ABSTRACT

The invention relates to a novel pet flotation and safety vest device wherein the body section attaches firmly yet comfortably to the pet, and strategically placed mesh panels allow for water drainage. A padded chip strap also has mesh sections for drainage and a strategically located top grab strap that will keep the animal level when it is being pulled from the water. The underside of the vest also has a reinforced grab strap in the event an animal may be upside down in the water.

### FIELD

The invention relates to a novel pet flotation and safety vest device wherein the body section attaches firmly yet comfortably to the pet, and strategically placed mesh panels allow for water drainage. A padded chip strap with drainage aids in keeping the pet's head above water.

### BACKGROUND OF THE INVENTION

The invention most closely corresponds with USPTO Class 119/174 wherein Class 119 relates to animal husbandry and sub-class 174 includes miscellaneous animal items not included in any specific sub-class.

In its simplest form, the invention relates to a novel pet flotation and safety vest device. Essentially a life vest or life preserver for dogs.

The inventive vest is designed not only for optimal floatation, it is also designed to allow water to drain from the vest whereas many pet life vests simply become saturated and floatation is hampered as well as retrieving the pet from the water source is more difficult due to the weight.

A unique feature of the pet floatation and safety device is a separate padded chin strap which aids in holding the pet's head above water. This chin strap also has mesh panels to allow water drainage so the pet wearing the vest is easier to pull from the water than other life vests on the market. A reinforced handle is located on the top of the vest for the pet owner to readily grasp and pull the animal from the water without fumbling with a handhold or potentially having the vest material tear. Of key importance is the handle has been located on the vest in such a way that balances vest and pet so that the vest doesn't slide up against the pet's throat. In a case where the pet may be upside down in the water, an additional strap is located on the underside of the vest for quickly pulling the pet out of the water.

### THE INVENTION

### Summary, Objects and Advantages

Many dogs don't swim well or naturally and can drown as fast (or faster) than a person. Depending on the breed, the dog can tire easily in water so it is imperative that a pet owner bringing their dog along during water activities should always have the pet secured with a life preserving means.

Even dogs that swim well can tire very quickly, and because they don't understand the concept of resting or treading water—they just continue to swim until they are completely unable to swim any longer. A dog that is heavy on land is going to be much heavier when wet, and thus may be difficult for the pet owner to pull to safety. A flotation device is crucial not only for floatation, but also to aid in rescuing a waterborne dog.

Dogs that swim in large bodies of water such as large lakes or the ocean can also easily be pulled by the water's current. This is especially true of the ocean. Having a life vest allows the dog to float with the current or tides until the pet owner can safely rescue them.

There are many pet life vests on the market, but the problem with most is that they do not drain easily, or they are not configured in such a way as to accommodate varying sizes of dogs. Another problem with current life vests is that they do little to promote the pet's head remaining well above the water. When a dog tires its head will want to naturally droop. This can easily lead to drowning. Most life vests on the market use a one-size fits all model which doesn't allow for specific anatomical consideration related to the animal's weight, rate of fatigue, keeping the dog's head well above the water surface, and efficient drainage of the vest. Applicant's vest has individual sections sewn or quilted in to the top and sides of the vest which contain buoyant material so that not only does the vest drain easily, the individual flotation sections aid in keeping the pet floating and doing so in an upright position. Large sections of buoyant material may be sewn into the vest or smaller quilted in portions to accommodate varying pet weights.

Further to the lack of a separate chin strap section of life vests currently on the market is that most vests simply have a section which fits under a dog's chin but is constructed into the vest as a one-piece continuous section of fabric. This method is not adjustable and thus is not optimized for dogs of various sizes. Nor does this construction offer optimum head buoyancy so that a tired dog can still keep its head above water. The inventive vest has an adjustable chin floatation section which adjusts to the dog as well as contains mesh for drainage of the chin flotation section as does the mesh in the body of the vest.

Finally, Applicant has conducted research into where a lift handle should be located and sewn onto the vest so that when any pet is being pulled from the water they will remain balanced and the vest or chin strap will not slide up and become tight on the pet's throat, or cause an imbalance of both and make retrieval from the water difficult. Applicant has conducted numerous studies before deciding on its top strap placement. Additionally, in rare cases where a pet might end up being upside down in the water, a nylon strap is also located on the bottom or belly side of the vest. Strap placement is a common error in the design of the prior art vests, so Applicants top strap placement, adjustable mesh chin strap, and underside mesh for water drainage must be considered novel.

### BRIEF DESCRIPTION OF THE DRAWINGS

The invention is described in further detail by reference to nine (9) drawings sufficient in detail to describe the invention in which:

FIG. 1 shows the vest from the underside;

FIG. 2 illustrates the vest as fitted onto a dog in phantom;

FIG. 3 is a side perspective of the vest, straps, and chin section;

FIG. 4 illustrates the side perspective of FIG. 3 with a dog in phantom;

FIG. 5 is a top perspective of the vest;

FIG. 6 is a side perspective with a dog in phantom illustrating the “grab strap” or handle;

FIG. 7 is an underside view showing the mesh drainage sections, straps, and leg holes;

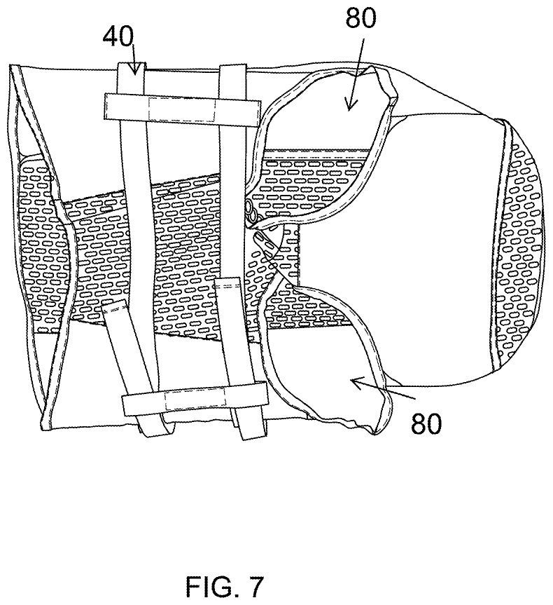

FIG. 8 is a side perspective illustrating the drainage sections, straps and leg holes;

FIG. 9 is an underside perspective to with drainage sections and lower handle strap.

### DETAILED DESCRIPTION, INCLUDING BEST MODES OF CARRYING OUT THE INVENTION

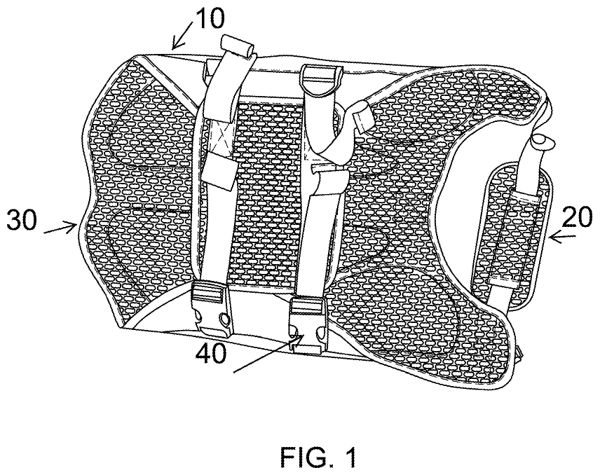

FIG. 1 shows the underside of the vest. The general body section 10 illustrates the vest. The meshed chin strap 20 is also adjustable with mesh for water drainage as well as buoyant materiel therein. Two adjustable nylon belly straps are shown with quick release buckles 40. The mesh portions 30 extend the length of the vest so that water drains from the entire vest making it easier for the pet owner to retrieve the dog from a body of water. These are not cosmetic features; these are functional and novel over the prior art.

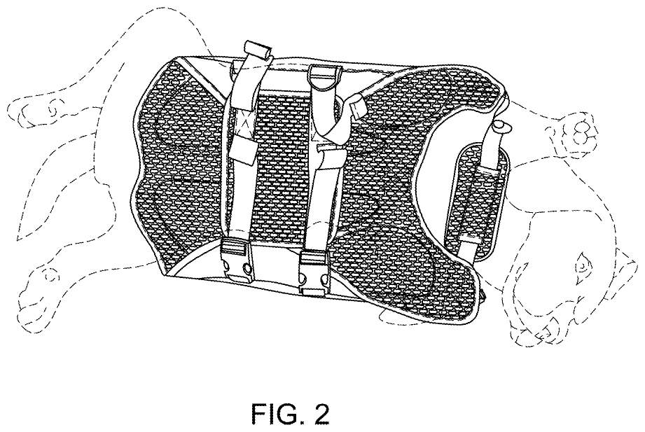

FIG. 2 shows the features of the vest in FIG. 1 with a dog in phantom to clearly illustrate how the vest will fit the dog.

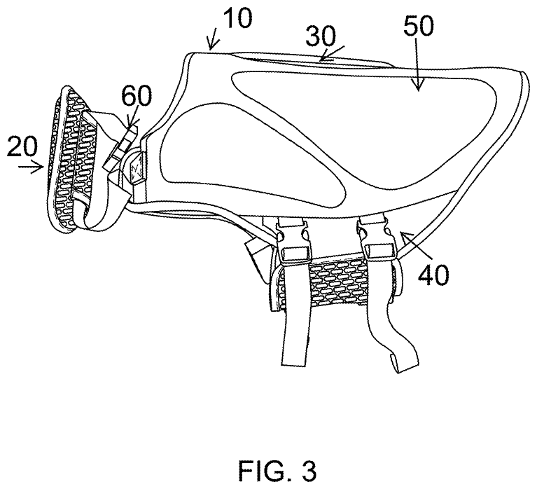

FIG. 3 is a side view of the vest body 10 and the adjustable chin strap with buoyant material and mesh 20. The chin strap also has a quick release buckle 60 for easy affixing and releasing the strap from the pet. Again, the adjustable belly straps with quick release buckles are shown 40. The top handle 70 is shown in this Fig as placed for optimum dispersion of weight when an animal is pulled from the water. This placement keeps the pet stable in the center of the vest so as not to tip fore or aft and keeps the vest from bunching up and squeezing either the neck or backside of the animal. This makes retrieval from the water much easier than vests in the current art. An example of large quilted in buoyant material sections are shown 50 as one embodiment. Smaller sections of buoyant material may be quilted into the vest for lower weight animals.

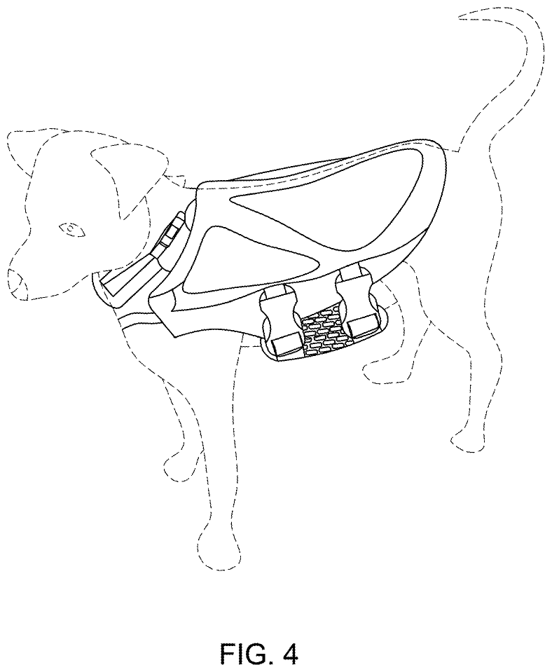

FIG. 4 shows the vest with a dog in phantom to clearly illustrate the perspective view as in FIG. 3 wherein the reader can easily see the fit as would be when the vest is attached to a dog.

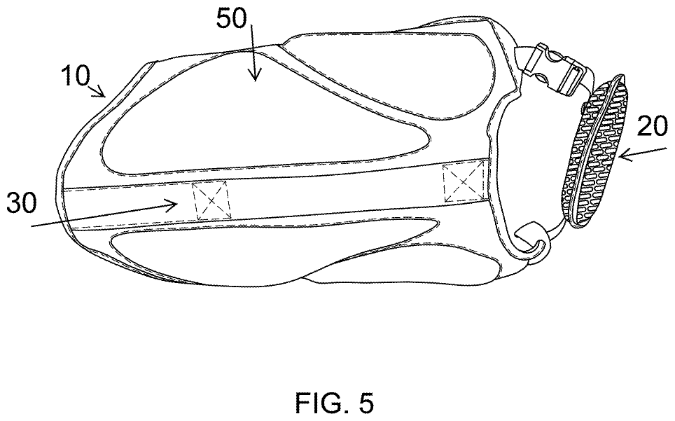

FIG. 5 is a top perspective of the vest and illustrates again the large quilted in flotation sections 50 and the chin strap 20. A reinforced stitched handle or “grab strap” 70 is located on top of the vest so that the pet owner can easily grasp the handle and pull a dog from the water. This Fig illustrates the reinforced stitching that will be located under the grab handle and will not typically be seen, but important to the present Application to indicate strength of the strap connection to the vest.

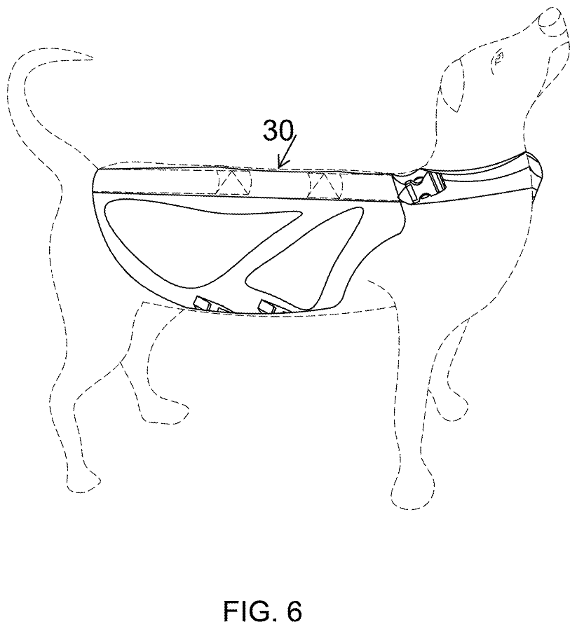

FIG. 6 is a perspective view with a dog in phantom to illustrate the reinforced handle or “grab strap” 70 as would approximate the example when the vest is attached to a dog.

Fig. shows the underside of the vest with the strap portions 40 and without the chin strap. There are two openings 80 for the legs of the animal to be securely strapped into the vest yet allow the legs to move freely when the pet is in the water.

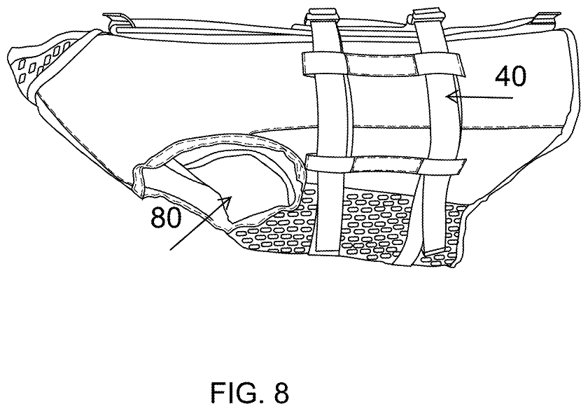

FIG. 8 is a side perspective showing the underside mesh drainage section 30 as well as the leg openings 80 and a portion of the adjustable nylon straps 40.

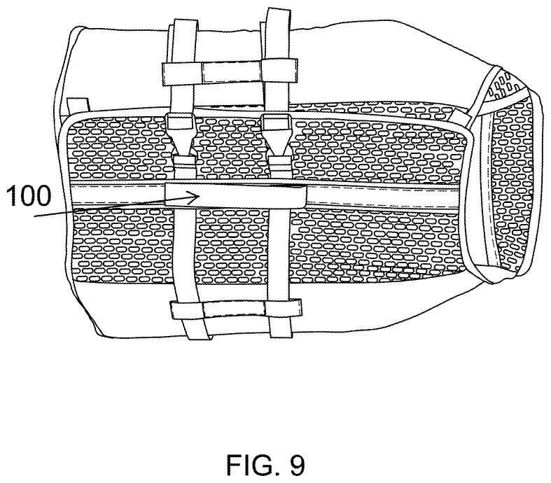

FIG. 9 is a bottom view of the vest again showing the mesh portions 30, and the leg openings 80. In this Figure the nylon strap 100 is stitched into the bottom or underside of the vest in the case that a pet may be upside down in the water. This is not common but would present a serious drowning risk if the pet could not be easily pulled from the water without a way to grasp the vested animal and pull out of the water. This secondary protection is also novel in the market.

1) A pet flotation and safety vest device comprising:
a) A neoprene body with buoyant material sewn into the vest body;
b) 2 adjustable nylon belly straps with quick release buckles;
c) An adjustable nylon chin strap containing buoyant material and meshing with a quick release buckle;
d) A reinforced nylon handle or “grab strap” on the top side of the device;
e) A bottom or underside reinforced nylon grab strap sewn into the belly side of the vest;
f) Mesh fabric located the full length of the lower portion of the vest for water drainage.

2) The pet flotation and safety vest device as in claim 1 wherein the material for the body of the vest is Neoprene.

3) The pet flotation and safety vest device as in claim 1 wherein the nylon adjustable belly straps are made so that a length of the strap may be pulled outward or inward depending on the size of the dog, and wherein 2 quick release buckles affix the straps around the belly of the dog.

3) The pet flotation and safety vest device as in claim 1 wherein the neoprene body of the vest contains at least 4 sections wherein buoyant material is sewn separately onto the vest for floatation and said sections shall extrude farther outward than the sections without buoyant material therein.

4) The pet flotation and safety vest device as in claim 1 wherein a nylon and neoprene chin strap contains buoyant material and mesh fabric for water drainage, and is adjustable by extending or retracting a portion of the nylon strap depending on the size of the dog, and wherein said strap connects via a quick release buckle.

5) The pet flotation and safety vest device as in claim 1 wherein a nylon handle or “grab strap” is reinforceably located on the top side of the vest via a criss-cross stitch pattern and whereby the location of the grab strap controls the stability of the wet animal by being placed in such a position as to keep the pet from being fore or aft heavy and thus a user is able to pull the wet animal from the water easily and in a level manner as well as preventing the weight to tear the handle from the vest body.

6) The pet flotation and safety vest device as in claim 1 wherein the underside or belly side of the vest contains a reinforced nylon grab strap in case the animal is upside down in the water and faces potential drowning if a pet owner cannot easily locate a place on the underside of a vest to pull the animal from the water.
